(19) United States
(12) Patent Application Publication
(10) Pub. No.: US 2008/0133636 A1
(43) Pub. Date: Jun. 5, 2008

(54) HIGH PASS FILTER

(76) Inventors: Norman J. Beamish, Airport Business Park (IE); Conor O'Keeffe, Douglas (IE); Richard A. Verellen, Poplar Grove, IL (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/567,020

(22) Filed: Dec. 5, 2006

(51) Int. Cl. G06G 7/02

(52) U.S. Cl. 708/819

(57) ABSTRACT

A high pass filter adapted for use in a signal processing device comprising a sampler adapted to sample a signal and transmit the samples to the high pass filter, the high pass filter comprising a differentiator and an integrator; a counter which, in use, counts the number of samples received by the high pass filter from the sampler; and a control device which receives a first signal from the counter when the high pass filter has received a first sample from the sampler and receives a second signal from the counter when the high pass filter has received a second or subsequent sample from the sampler; whereupon receipt of the first signal, the control device causes the integrator output signal to substantially equal zero and whereupon receipt of the second signal, the control device causes the integrator output to be a function of an input signal from the differentiator.

### FIELD OF THE INVENTION

The present invention relates to a filter, and in particular, a high pass filter.

### BACKGROUND OF THE INVENTION

Enhanced data rate for GSM evolution (EDGE) is a new specification for data transfer under the global system for mobile communications (GSM) protocol. The EDGE specification provides for higher data rates than GSM, thereby making greater demands on the performance of receivers and transmitters.

Referring to FIG. 1, a GSM receiver 2 is typically connected to a transmission medium 3 in accordance with the time division multiplex averaging (TDMA) protocol. Under this protocol, time is segmented into intervals called frames, wherein each frame is divided into a plurality of assignable time slots, and the receiver 2 can only access the transmission medium 3 during a one or more slots assigned thereto. Thus, to receive an incoming signal on the transmission medium 3, the receiver 2 must be switched on during its assigned slot(s). However, to conserve energy (and prolong its battery life), the receiver 2 must not be switched on all the time. Instead, the receiver 2 should only be switched on for the duration of its allocated slot(s) and a short preceding period (to allow the receiver to warm up).

The receiver 2 further comprises a circuitry block 4 for inter alia processing an incoming signal on the transmission medium 3. The circuitry block 4 is connected to a sampling system 5 which samples signals from the circuitry block 4 at a pre-determined sampling rate. The sampling system 5 provides the sampled signals to a processing module 6 for further processing. When the receiver 2 is switched on, even if it is not yet receiving an incoming signal on the transmission medium 3, the receiver's circuitry block 4 generates a DC offset signal. In the absence of an incoming signal on the transmission medium 3, the sampling system 5 samples the DC offset signal and transmits the resulting samples to the processing module 6. However, when an incoming signal is received on the transmission medium 3, the incoming signal is overlaid with the DC offset signal. Thus, the DC offset signal must be removed from the incoming signal so that it can be accurately processed by the processing module 6.

A DC offset signal can be removed by techniques such as high pass filtering or DC cancellation. In the high pass filtering approach, a high pass filter (HPF) 7 is inserted between the sampling system 5 and the processing module 6. The response of the HPF 7 to a DC offset comprises a transient component (whose duration is directly related to the sharpness of the HPF) followed by a steady state component. However, the receiver 2 cannot be used until the HPF 7 has reached steady state. Thus, the longer the duration of a HPF's transient component, the earlier the receiver 2 must be switched on in advance of its allocated slot. The DC cancellation scheme comprises the steps of estimating the DC offset of the receiver 2 and subtracting the estimate from subsequently received signals. This approach has the advantage that the receiver 2 can process an incoming signal without adding a delay to the signal itself (although the receiver will need to be activated for an interval prior to the arrival of the signal so the DC offset can be estimated). However, if the initial estimate of the DC offset is inaccurate, the DC cancellation scheme will not be successful and the receiver 2 will retain a DC offset.

U.S. Pat. No. 5,777,909 describes a scheme which reduces the duration of a HPF transient response by switching between two separate HPF coefficient sets.

However, the implementation of this scheme requires complex digital hardware.

### BRIEF DESCRIPTION OF THE DRAWINGS

Two embodiments of the invention will now be described by way of example only, with reference to the accompanying figures in which:

FIG. 1 is a block diagram of a GSM receiver;

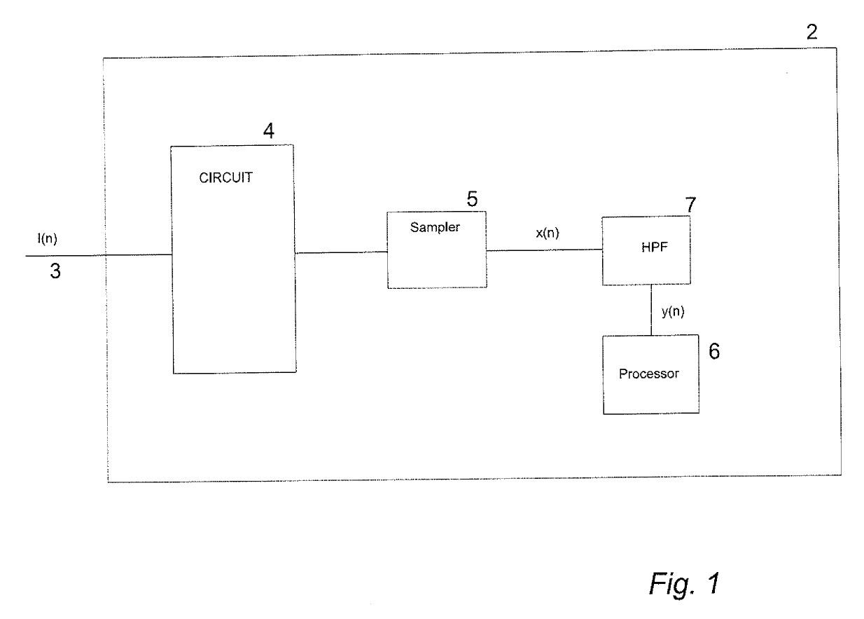

FIG. 2 is a block diagram of a prior art HPF;

FIG. 3 is a block diagram of a HPF in accordance with the embodiment;

FIG. 4 is a graph of the time domain responses of the HPF in accordance with the embodiment (shown in FIG. 3) and the prior art HPF (shown in FIG. 2), to a DC signal; and

FIG. 5 is a graph of the time domain responses of the HPF in accordance with the embodiment (shown in FIG. 3) and the prior art HPF (shown in FIG. 2), to a signal comprising a sinusoidal (tone) component and a DC component.

### DETAILED DESCRIPTION OF THE PREFERRED EMBODIMENTS

### 1. Conventional HPF

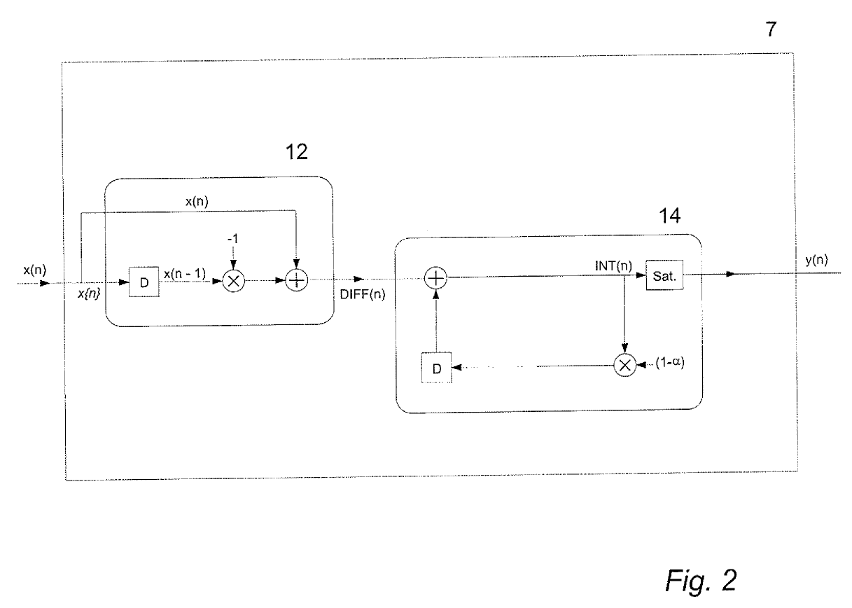

Referring to FIG. 2, a prior art HPF 7 comprises a differentiator 12 directly connected to an integrator 14. Let the input and output signals from the HPF 7 at sample n be given by x(n) and y(n) respectively. In this case, the output from differentiator 12 at sample n (namely DIFF(n)) may be represented as DIFF(n)=x(n)−x(n−1). Accordingly, if an input signal to the differentiator 12 comprises a constant term (i.e. a DC offset), the differentiator 12 will remove the constant term. However, the differentiator 12 also attenuates the entire frequency spectrum of the signal. The integrator 14 compensates for this attenuation. The integrator 14 comprises a feedback loop and since it is directly connected to the differentiator 12, the output from the integrator 14 (represented by INT(n)) may be given by INT(n)=DIFF(n)+(1−α)INT(n−1).

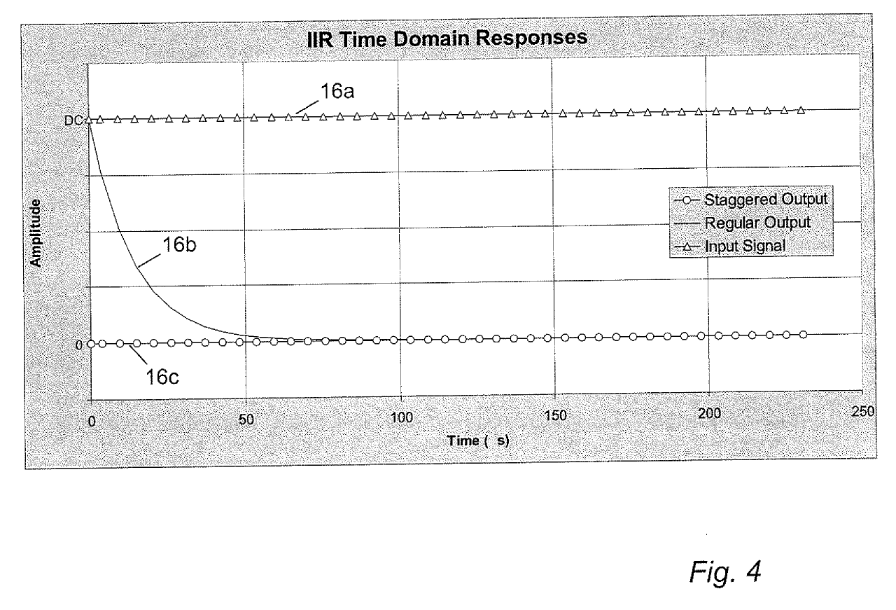

Referring to FIG. 2 together with FIG. 4, let an input signal 16a to the HPF 7 be a DC signal (corresponding with a DC offset generated by the receiver's circuitry block without an incoming signal on a transmission medium) of value DC (i.e. x(1)=DC, x(2)=DC, . . . , x(n)=DC) and let the differentiator 12 be initialized to 0 (i.e. x(0)=0); the output from the differentiator 12 in response to the first sample (n=1) of the input signal 16a, is given by DIFF(1)=x(1)−x(0) (i.e. DIFF(1)=DC). The output from the differentiator 12 in response to the second sample is given by DIFF(2)=x(2)−x(1) (i.e. DIFF(2)=DC−DC=0). Similarly, DIFF(3)=0, DIFF(4)=0 and so on. Thus the response of the differentiator 12 to the DC signal 16a (i.e. a DC offset generated by the receiver's circuitry without an incoming signal on a transmission medium) effectively takes the form of a pulse. The feedback structure of the integrator 14 causes it to produce an exponentially decaying 16b output in response to the pulse from the differentiator 12. The exponential decay from the integrator 14 appears in the overall output signal y(n) from the HPF 10 as the transient component therein.

### 2. HPF of the Present Embodiment

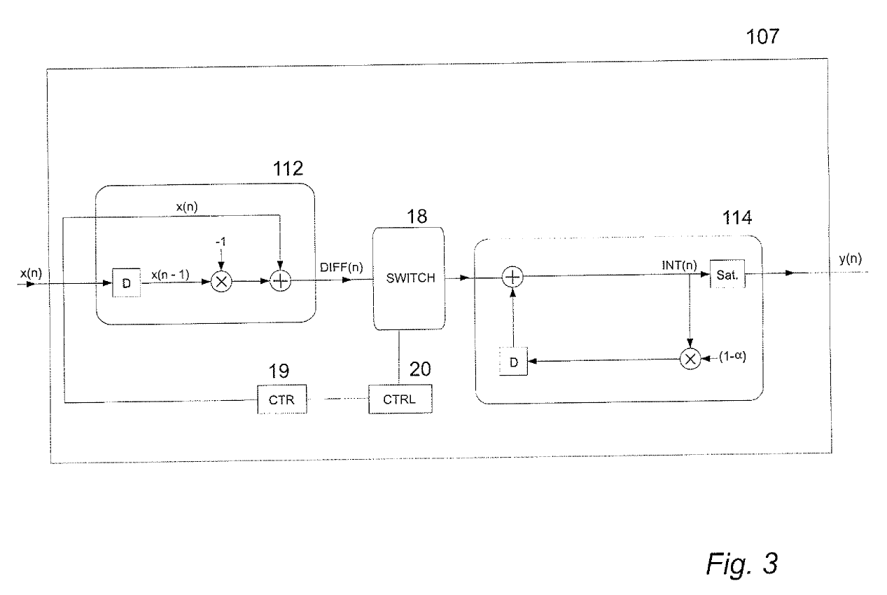

Referring to FIG. 3, the HPF 107 of the present embodiment comprises a differentiator 112 and an integrator 114. The integrator 114 is connected to a switch 18 controlled by a counter 19 and a control device 20 within the HPF 107. When a receiver comprising the HPF 107 is first switched on, the counter 19 is set to a value of one and the integrator input is disconnected from the differentiator 112 output. More specifically, the switch 18 connects the integrator 114 input to a DC signal of value zero.

Every sample received by the HPF 107 (from the receiver's sampling system) causes the counter 19 to increment by one. When the counter 19 attains a value greater than one (or more generally, the differentiator reaches its steady state DC ouput [i.e. 0] for higher order HPFs), the control device 20 transmits a control signal to the switch 18 to cause the switch 18 to connect the integrator 114 to the differentiator 112. Thus, for the first sample (n=1) received from the receiver's sampling system, the integrator is connected to zero and the output from the integrator 112 is therefore zero (i.e. INT(1)=0). For every sample received thereafter (i.e. n>1, wherein the differentiator has reached its steady state DC output) the integrator is connected to the differentiator 112 so that the output from the integrator is given by INT(n)=DIFF(n)+(1−α)INT(n−1). This in effect, allows the differentiator 112 to start (at least) one sample period earlier than the integrator 114. Thus, using the previous example of a DC input signal to the HPF 107, during the first sample of the signal, the switch 18 ensures that the pulse from the differentiator 112 has no effect on the output from the integrator 114. In other words referring to FIG. 3 together with FIG. 4, the switch 18 has the effect of removing the transient component from the output 16c of the integrator 114.

A second embodiment of the HPF also comprises a differentiator and an integrator. Furthermore, the integrator is connected to a switch controlled by a control device and a counter within the HPF. However, in the second embodiment, the switch does not control the connection between the differentiator and the integrator, since the integrator and the differentiator are permanently connected. Instead, in the second embodiment, the switch controls the state of activation or deactivation of the integrator. More particularly, when a receiver comprising the HPF is first switched on, the counter is set to a value of one and the switch deactivates the integrator. As in the first embodiment, every sample received from the receiver's sampling system causes the counter to increment by one. When the counter attains a value of at least greater than one (wherein the differentiator has reached its steady state DC output), the control device transmits a control signal to the switch, to cause the switch to activate the integrator. Thus, for the first sample (n=1) the integrator is inactive and its output is therefore zero (i.e. INT(1)=0). For every sample received thereafter (i.e. n>1 wherein the differentiator has reached its steady state DC output) the integrator is activated. Consequently, the output from the integrator is given by INT(n)=DIFF(n)+(1−α)INT(n−1). Thus, in a similar fashion to the first embodiment, the arrangement of the second embodiment effectively allows the differentiator to start at least one sample period earlier than the integrator. Thus, the switch has the effect of removing the transient component from the output of the integrator.

It should be noted that in both embodiments, once the entire signal in an allocated slot has been received, the receiver is switched off until its next allocated slot. On switching the receiver on again (to receive a signal during the next slot), the counter is reset to one.

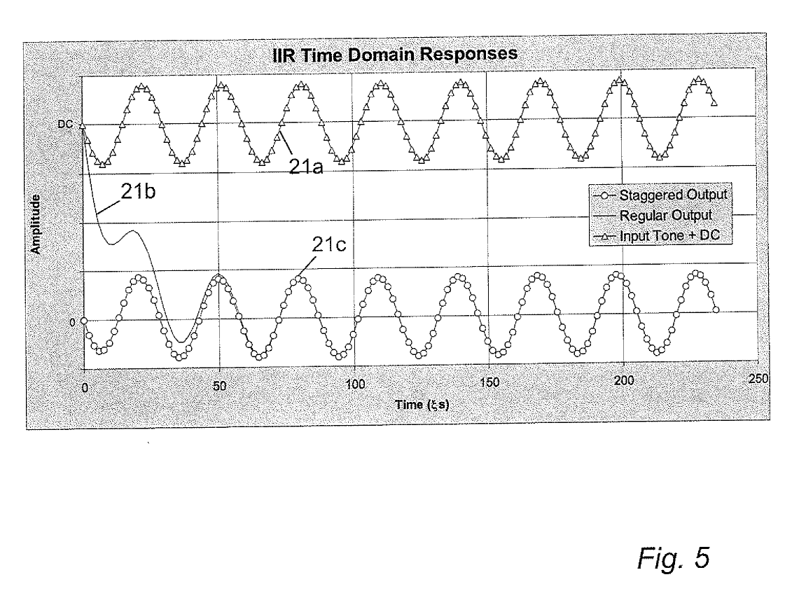

Referring to FIG. 5 together with FIG. 3, let an input signal 21a to the HPF 107 comprise a sinusoidal component and a DC component (so that it approximates the signal that would be received by a HPF when the associated receiver is receiving an incoming signal on a transmission medium). The response 21b from a conventional prior art HPF comprises a transient component of approximately 35 to 40 ms in duration before steady state is achieved. In contrast, the switch 18 in the HPF of the present embodiment reduces the transient component, so that the response 21c from the HPF of the present embodiment essentially mimics the shape and form of the input signal 21a. Further, it will be noted that the steady state response from the prior art HPF and the present embodiment are shifted down to zero compared with the input signal 21a to the HPF. This has occurred because the DC component in the input signal 21a (to the HPFs) has been removed by the differentiators in each HPF.

Accordingly the present embodiment allows DC offset and low frequency noise to be removed from signals in a radio receiver without adding a substantial transient component to the response of the receiver. Thus, in a GSM system, a device can switch between transmit and receive slots and between disjoint receive slots more quickly. Further, the present embodiment reduces the power consumption of a radio receiver, by reducing the amount of time the receiver must be powered on before receiving an incoming burst.

Whilst the above description is primarily focused on a first order high pass filter, it should be realised that the present embodiments are not limited to such high pass filters and could instead, be employed with any order high pass filter. Similarly, whilst the above description is essentially directed to GSM/EDGE receivers, nonetheless it will be appreciated that the embodiment is not limited to this particular application. Instead, the embodiment could be used much more generally in any signal processing system which uses a high pass filter to remove a DC offset whilst minimizing the duration of the HPF transient response.

Alterations and modifications may be made to the above without departing from scope of the invention.

1. A high pass filter adapted for use in a signal processing device comprising a sampler adapted to sample a signal and transmit the samples to the high pass filter, the high pass filter comprising:
a differentiator; and
an integrator;
a counter which, in use, counts the number of samples received by the high pass filter from the sampler; and
a control device which receives a first signal from the counter when the high pass filter has received a first sample from the sampler and receives a second signal from the counter when the high pass filter has received a second or subsequent sample from the sampler;
whereupon receipt of the first signal, the control device causes the integrator output signal to substantially equal zero and whereupon receipt of the second signal, the control device causes the integrator output to be a function of an input signal from the differentiator.

2. The high pass filter as claimed in claim 1, whereupon receipt of the first signal, the control device causes the integrator to be deactivated.

3. The high pass filter as claimed in claim 1, whereupon receipt of the second signal, the control device causes the integrator to be activated to receive the input signal from the differentiator.

4. The high pass filter as claimed in claim 1, wherein the high pass filter comprises a switch, which is in communication with the control device, so that, in use, upon receipt of the first signal, the control device causes the switch to deactivate the integrator.

5. The high pass filter as claimed in claim 4, whereupon receipt of the second signal, the control device causes the switch to activate the integrator.

6. The high pass filter as claimed in claim 1, whereupon receipt of the first signal, the control device causes the integrator to be connected to a substantially DC signal of value substantially equal to zero.

7. The high pass filter as claimed in claim 6, whereupon receipt of the second signal, the control device causes an input of the integrator to be connected to an output of the differentiator to receive the input signal from the differentiator.

8. The high pass filter as claimed in claim 6, wherein the high pass filter comprises a switch which is in communication with the control device, so that, in use, upon receipt of the first signal, the control device causes the switch to connect the integrator to a substantially DC signal of value substantially equal to zero.

9. The high pass filter as claimed in claim 8, whereupon receipt of the second or subsequent signal, the control device causes the switch to connect an input of the integrator to an output of the differentiator.

10. A GSM receiver comprising a high pass filter as claimed in claim 1.

11. An EDGE receiver comprising a high pass filter as claimed in claim 1.

12. A method of high pass filtering a signal in a signal processing device, comprising the steps of:
sampling the signal;
counting the number of samples in the sampled signal;
differentiating the sampled signal;
generating an output signal of value substantially equal to zero in response to a first sample from the signal; and
integrating the differentiated signal to generate an output signal that is a function of the differentiated signal in response to a second or subsequent samples of the signal.
